(19) United States
(12) Patent Application Publication
(10) Pub. No.: US 2017/0286432 A1
(43) Pub. Date: Oct. 5, 2017

(54) SYSTEM AND METHOD FOR GENERATING DRIVING ALERTS BASED ON MULTIMEDIA CONTENT

(71) Applicant: Cortica, Ltd., TEL AVIV (IL)

(72) Inventors: Igal Raichelgauz, Tel Aviv (IL); Karina Odinaev, Tel Aviv (IL); Yehoshua Y. Zeevi, Haifa (IL)

(73) Assignee: Cortica, Ltd., TEL AVIV (IL)

(21) Appl. No.: 15/625,187

(22) Filed: Jun. 16, 2017

Related U.S. Application Data
(63) Continuation-in-part of application No. 13/770,603, filed on Feb. 19, 2013.
Application No. 13/770,603 is a continuation-in-part of application No. 13/624,397, filed on Sep. 21, 2012, now Pat. No. 9,191,626.
Application No. 13/624,397 is a continuation-in-part of application No. 13/344,400, filed on Jan. 5, 2012, now Pat. No. 8,959,037.
Application No. 13/344,400 is a continuation of application No. 12/434,221, filed on May 1, 2009, now Pat. No. 8,112,376.
Application No. 13/624,397 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 13/624,397 is a continuation-in-part of application No. 12/084,150, filed on Apr. 7, 2009, now Pat. No. 8,655,801.
(60) Provisional application No. 62/351,672, filed on Jun. 17, 2016.
(60) Provisional application No. 62/351,978, filed on Jun. 19, 2016.

(30) Foreign Application Priority Data
Oct. 26, 2005 (IL) 171577
Jan. 29, 2006 (IL) 173409
Aug. 21, 2007 (IL) 185414

(51) Int. Cl. G06F 17/30; H04H 60/46; H04H 60/66; H04N 7/173; H04N 21/258; H04N 21/2668; H04N 21/466; H04N 21/81; H04H 20/26; H04H 60/37; H04H 60/56; H04H 20/10; H04L 29/08

(52) U.S. Cl. CPC G06F 17/30056; H04H 20/103; H04H 60/46; H04H 60/66; H04N 7/17318; H04N 21/25891; H04N 21/2668; H04L 67/10; H04N 21/8106; H04H 20/26; H04H 60/37; H04H 60/56; H04N 21/466

(57) ABSTRACT

A system and method for determining driving decisions based on multimedia content. The method includes obtaining, in real-time during a trip of a vehicle, a first set of multimedia content elements captured by at least one sensor deployed in proximity to the vehicle; and generating, in real-time, a driving alert, when it is determined that at least one signature generated for the first set of multimedia content elements matches at least one signature generated for a matching multimedia content element of a second set of multimedia content elements, wherein each of the second set of multimedia content elements is associated with a predetermined potential cause of collision.

### CROSS-REFERENCE TO RELATED APPLICATIONS

This application claims the benefit of U.S. Provisional Application No. 62/351,672 filed on Jun. 17, 2016, and of U.S. Provisional Application No. 62/351,978 filed on Jun. 19, 2016. This application is also a continuation-in-part of U.S. patent application Ser. No. 13/770,603 filed on Feb. 19, 2013, now pending, which is a continuation-in-part (CIP) of U.S. patent application Ser. No. 13/624,397 filed on Sep. 21, 2012, now U.S. Pat. No. 9,191,626. The Ser. No. 13/624,397 Application is a CIP of:

(a) U.S. patent application No. 13/344,400 filed on Jan. 5, 2012, now U.S. Pat. No. 8,959,037, which is a continuation of U.S. patent application Ser. No. 12/434,221 filed on May 1, 2009, now U.S. Pat. No. 8,112,376;

(b) U.S. patent application Ser. No. 12/195,863 filed on Aug. 21, 2008, now U.S. Pat. No. 8,326,775, which claims priority under 35 USC 119 from Israeli Application No. 185414, filed on Aug. 21, 2007, and which is also a continuation-in-part of the below-referenced U.S. patent application Ser. No. 12/084,150; and

(c) U.S. patent application Ser. No. 12/084,150 having a filing date of Apr. 7, 2009, now U.S. Pat. No. 8,655,801, which is the National Stage of International Application No. PCT/IL2006/001235, filed on Oct. 26, 2006, which claims foreign priority from Israeli Application No. 171577 filed on Oct. 26, 2005, and Israeli Application No. 173409 filed on Jan. 29, 2006.

All of the applications referenced above are herein incorporated by reference.

### TECHNICAL FIELD

The present disclosure relates generally to autonomous driving, and more particularly to generating alerts for avoiding collisions by autonomous vehicles based on analysis of multimedia content.

### BACKGROUND

In part due to improvements in computer processing power and in location-based tracking systems such as global positioning systems, automated and other assisted driving systems have been developed with the aim of providing driverless control or driver-assisted control of vehicles during transportation. An autonomous vehicle includes a system for controlling the vehicle based on the surrounding environment such that the vehicle autonomously controls functions such as accelerating, braking, steering, and the like.

Existing solutions for automated driving may use a global positioning system receiver, electronic maps, and the like, to determine a path from one location to another. Fatalities and injuries due to vehicles colliding with people or obstacles during the determined path are significant concerns for developers of autonomous driving systems. To this end, automated driving systems may utilize sensors such as cameras and radar for detecting objects to be avoided. However, not all vehicles in the near future will be autonomous, and even among autonomous vehicles, additional safety precautions are warranted.

Some existing automatic driving solutions engage in automatic or otherwise autonomous braking in order to avoid or minimize collisions. However, such solutions face challenges in accurately identifying obstacles. Moreover, such solutions typically stop the vehicle using a predetermined acceleration upon detection of a potential collision that does not account for the obstacle to be avoided. As a result, the automatically braking vehicle may stop unnecessarily quickly or may not stop quickly enough. Such results are undesirable because, at least in some circumstances, they may result in collisions or otherwise damage the vehicle. In particular, stopping quickly may result in a rear collision with a vehicle behind the automatically braking vehicle.

It would be therefore advantageous to provide a solution for accurately detecting and alerting an autonomous vehicle to obstacles.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for generating driving alerts based on multimedia content. The method comprises: obtaining, in real-time during a trip of a vehicle, a first set of multimedia content elements captured by at least one sensor deployed in proximity to the vehicle; and generating, in real-time, a driving alert, when it is determined that at least one signature generated for the first set of multimedia content elements matches at least one signature generated for a matching multimedia content element of a second set of multimedia content elements, wherein each of the second set of multimedia content elements is associated with a predetermined potential cause of collision.

Certain embodiments disclosed herein also include a non-transitory computer readable medium having stored thereon causing a processing circuitry to execute a process, the process comprising: obtaining, in real-time during a trip of a vehicle, a first set of multimedia content elements captured by at least one sensor deployed in proximity to the vehicle; and generating, in real-time, a driving alert, when it is determined that at least one signature generated for the first set of multimedia content elements matches at least one signature generated for a matching multimedia content element of a second set of multimedia content elements, wherein each of the second set of multimedia content elements is associated with a predetermined potential cause of collision.

Certain embodiments disclosed herein also include a system for generating driving alerts based on multimedia content. The system comprises: a processing circuitry; and a memory, the memory containing instructions that, when executed by the processing circuitry, configure the system to: obtaining, in real-time during a trip of a vehicle, a first set of multimedia content elements captured by at least one sensor deployed in proximity to the vehicle; and generating, in real-time, a driving alert, when it is determined that at least one signature generated for the first set of multimedia content elements matches at least one signature generated for a matching multimedia content element of a second set of multimedia content elements, wherein each of the second set of multimedia content elements is associated with a predetermined potential cause of collision.

### BRIEF DESCRIPTION OF THE DRAWINGS

The subject matter that disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of an alert generator according to an embodiment.

FIG. 3 is a flowchart illustrating a method for generating driving alerts based on multimedia content elements according to an embodiment.

FIG. 4 is a block diagram depicting the basic flow of information in the signature generator system.

FIG. 5 is a diagram showing the flow of patches generation, response vector generation, and signature generation in a large-scale speech-to-text system.

### DETAILED DESCRIPTION

It is important to note that the embodiments disclosed herein are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

A system and method for generating driving alerts based on multimedia content elements. Input multimedia content elements captured by at least one sensor deployed in proximity to a vehicle are obtained. Signatures are generated for the input multimedia content elements. The generated signatures are compared to a plurality of signatures representing reference multimedia content elements showing known causes of collisions. Each reference multimedia content element may be associated with at least one predetermined potential cause of collision, at least one predetermined collision parameter, at least one predetermined collision avoidance instruction, a combination thereof, and the like. Based on the comparison, it is determined whether a reference multimedia content element matches at least one of the input multimedia content elements and, if so, an alert may be generated and sent to an automated driving system configured to control the vehicle. In some embodiments, the collision avoidance instructions associated with the matching reference multimedia content element may be caused to be executed.

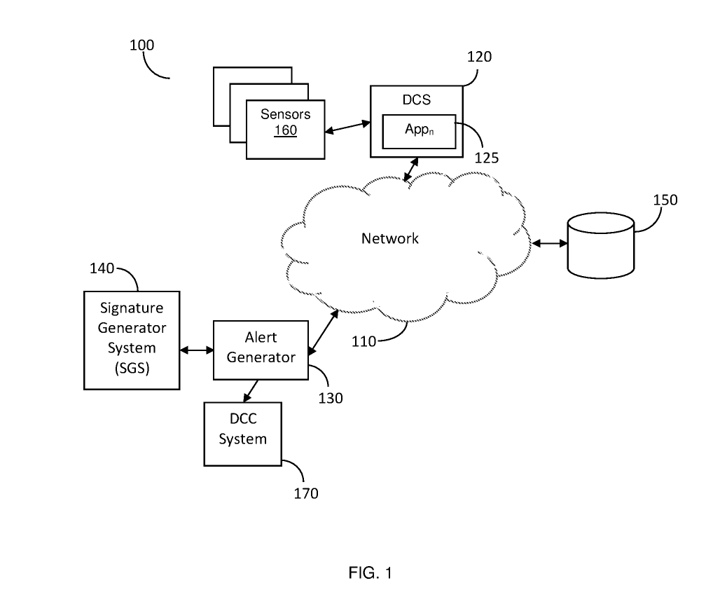

FIG. 1 is an example network diagram 100 utilized to describe the various embodiments disclosed herein. The network diagram 100 includes a driving control system 120, an alert generator 130, a database 150, and at least one sensor 160, communicatively connected via a network 110. The network 110 may be, but is not limited to, the Internet, the world-wide-web (WWW), a local area network (LAN), a wide area network (WAN), a metro area network (MAN), and other networks capable of enabling communication between the elements of the network diagram 100.

The driving control system 120 is configured to generate driving decisions in real-time during a trip of a vehicle (not shown) based on sensor signals captured by sensors 160 deployed in proximity to the vehicle. In an example implementation, the driving control system 120, the sensors 160, or both, may be disposed in or affixed to the vehicle. The trip includes movement of the vehicle from at least a start location to a destination location. During the trip, at least visual multimedia content elements are captured by the sensors 160.

At least one of the sensors 160 is configured to capture visual multimedia content elements demonstrating characteristics of at least a portion of the environment (e.g., roads, obstacles, etc.) surrounding the vehicle. In an example implementation, the sensors 160 include a camera installed on a portion of a vehicle such as, but not limited to, a dashboard of the vehicle, a hood of the vehicle, a rear window of the vehicle, and the like. The visual multimedia content elements may include images, videos, and the like. The sensors 160 may be integrated in or communicatively connected to the driving control system 120 without departing from the scope of the disclosed embodiments.

The driving control system 120 may have installed thereon an application 125. The application 125 may be configured to send multimedia content elements captured by the sensors 160 to the alert generator 130, and to receive alerts from the alert generator 130. The application 125 may be further configured to receive collision avoidance instructions to be executed by the driving control system 120 from the alert generator 130.

The database 150 may store a plurality of previously captured reference multimedia content elements and associated potential causes of collisions, collision parameters, automatic braking instructions, or a combination thereof. Each reference multimedia content element is a previously captured multimedia content element demonstrating a known potential cause of collision such as, for example, an obstacle previously captured in multimedia content elements prior to known collisions. Such potential causes may include, but are not limited to, moving objects (e.g., other vehicles, pedestrians, animals, etc.) and static objects (e.g., parked cars, buildings, boardwalks, trees, bodies of water, etc.). As a non-limiting example, a reference multimedia content element may be a video captured by a camera on a reference vehicle showing another vehicle's movements (or lack thereof) relative to the reference vehicle immediately prior to a collision.

Each of the reference multimedia content elements may further be associated with at least a portion of the reference vehicle from which it was captured such that each reference multimedia content element may represent an obstacle that caused a collision with respect to the associated portion of the reference vehicle. Portions of a vehicle may include, but are not limited to, front or rear side, driver side or passenger side, combinations thereof, and the like. A reference multimedia content element may be associated with the portion of the vehicle from which the reference multimedia content element was captured. As a non-limiting example, a reference image captured from a camera disposed on a hood on the driver side of the reference vehicle is associated with a front driver side portion of the vehicle. Indicating reference multimedia content elements with respect to portions of a vehicle may increase accuracy of alerting by indicating more precisely where the cause of the collision was relative to the vehicle, and may further be utilized to cause appropriate braking or other actions for avoiding collisions. For example, an input multimedia content element matching a reference multimedia content element showing a cause of collision on the front side of the vehicle may indicate that braking is required (i.e., to stop the vehicle from moving forward toward the cause of collision), while an input multimedia content element matching a reference multimedia content element showing a cause of collision on the rear side of the vehicle may indicate that braking is not required (i.e., that the vehicle should continue moving forward at the same or greater speed to avoid a collision from behind).

In an example implementation, a signature generator system (SGS) 140 and a deep-content classification (DCC) system 170 are connected to the network 110 and may be utilized by the alert generator 130 to perform the various disclosed embodiments. Each of the SGS 140 and the DCC system 170 may be connected to the alert generator 130 directly or through the network 110. In certain configurations, the SGS 140, the DCC system 170, or both may be embedded in the alert generator 130.

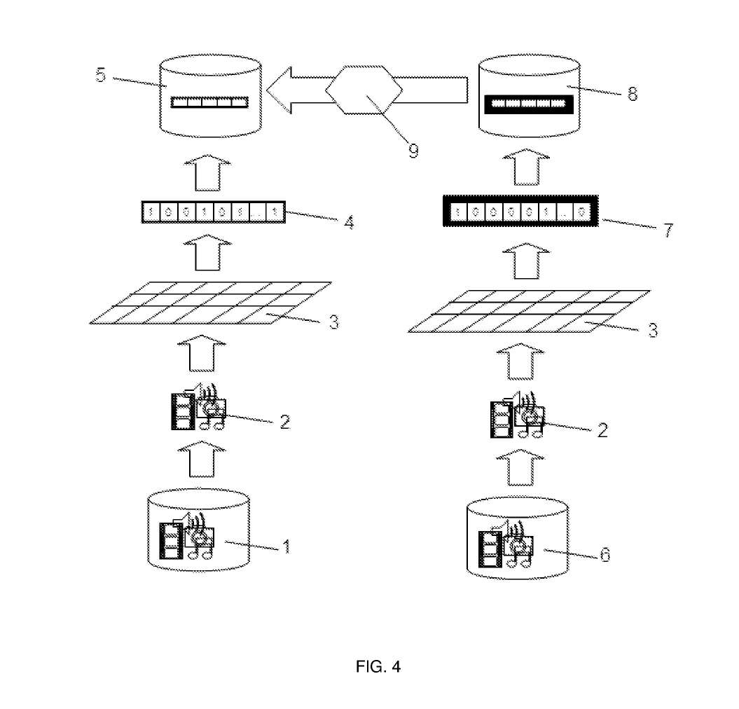

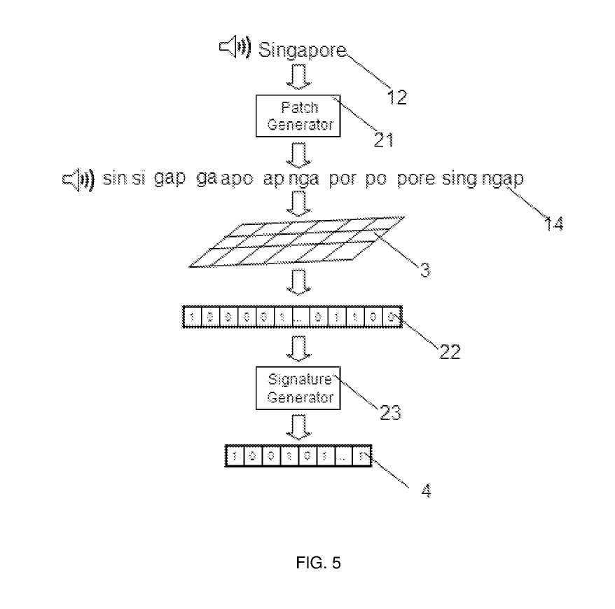

The SGS 140 is configured to generate signatures to multimedia content elements and includes a plurality of computational cores, each computational core having properties that are at least partially statistically independent of each other core, where the properties of each core are set independently of the properties of each other core. Generation of signatures by the signature generator system is described further herein below with respect to FIGS. 4 and 5.

The deep content classification system 170 is configured to create, automatically and in an unsupervised fashion, concepts for a wide variety of multimedia content elements. To this end, the deep content classification system 170 may be configured to inter-match patterns between signatures for a plurality of multimedia content elements and to cluster the signatures based on the inter-matching. The deep content classification system 170 may be further configured to reduce the number of signatures in a cluster to a minimum that maintains matching and enables generalization to new multimedia content elements. Metadata of the multimedia content elements is collected to form, together with the reduced clusters, a concept. An example deep content classification system is described further in U.S. Pat. No. 8,266,185, assigned to the common assignee, the contents of which are hereby incorporated by reference.

In an embodiment, the alert generator 130 is configured to send the input multimedia content elements to the signature generator system 140, to the deep content classification system 170, or both. In a further embodiment, the alert generator 130 is configured to receive a plurality of signatures generated to the input multimedia content elements from the signature generator system 140, to receive a plurality of signatures (e.g., signature reduced clusters) of concepts matched to the input multimedia content elements from the deep content classification system 170, or both. In another embodiment, the alert generator 130 may be configured to generate the plurality of signatures, identify the plurality of signatures (e.g., by determining concepts associated with the signature reduced clusters matching the multimedia content element to be tagged), or a combination thereof.

Each signature represents a concept, and may be robust to noise and distortion. Each concept is a collection of signatures representing multimedia content elements and metadata describing the concept, and acts as an abstract description of the content to which the signature was generated. As a non-limiting example, a ‘Superman concept’ is a signature-reduced cluster of signatures describing elements (such as multimedia elements) related to, e.g., a Superman cartoon: a set of metadata representing proving textual representation of the Superman concept. As another example, metadata of a concept represented by the signature generated for a picture showing a bouquet of red roses is “flowers”. As yet another example, metadata of a concept represented by the signature generated for a picture showing a bouquet of wilted roses is “wilted flowers”.

In an embodiment, based on the signatures, the concepts, or both, the alert generator 130 may be configured to determine a context of the input multimedia content elements. Determination of the context allows for contextually matching between the potential cause of collision shown in the input multimedia content elements and a predetermined potential cause of collision shown in the reference multimedia content element. Determining contexts of multimedia content elements is described further in the above-noted U.S. patent application Ser. No. 13/770,603, assigned to the common assignee, the contents of which are hereby incorporated by reference.

In an embodiment, the alert generator 130 is configured to obtain, in real-time, input multimedia content elements from the driving control system 120 that are captured by the sensors 160 during the trip. At least some of the input multimedia content elements are visual multimedia content elements showing potential causes of collisions. Each potential cause of collision may be an obstacle (e.g., pedestrians, animals, other vehicles, etc.) that may require altering driving of the vehicle (e.g., by braking, accelerating, turning, etc.).

In an embodiment, based on the input multimedia content elements, the alert generator 130 is configured to determine whether any reference multimedia content element matches the input multimedia content elements and, if so, to detect a potential collision. In an embodiment, determining whether there is a matching reference multimedia content element includes generating at least one signature for each input multimedia content element and comparing the generated input multimedia content signatures to signatures of the event multimedia content elements. In another embodiment, the alert generator 130 is configured to send the input multimedia content elements to the SGS 140, to the deep content classification system 170, or both, and receiving the generated signatures, at least one concept matching the input multimedia content elements, or both.

Each reference multimedia content element is a previously captured multimedia content element demonstrating an obstacle or other potential cause of a collision. The matching reference multimedia content element may be identified from among, e.g., reference multimedia content elements stored in the database 150. Each reference multimedia content element may be associated with at least one predetermined potential cause of collision, at least one predetermined collision parameter (e.g., a distance from the potential cause of collision to the vehicle, an angle of the position of the potential cause of collision relative to the vehicle, etc.), predetermined collision avoidance instructions, and the like. The collision avoidance instructions include, but are not limited to, one or more instructions for controlling the vehicle to, e.g., avoid an accident due to colliding with one or more obstacles.

Each reference multimedia content element may further be associated with a portion of a vehicle so as to indicate the location on the vehicle from which the reference multimedia content element was captured. To this end, in some embodiments, a reference multimedia content element may only match an input multimedia content element if, in addition to any signature matching, the reference multimedia content element is associated with the same or a similar portion of the vehicle (e.g., a portion on the same side of the vehicle). As a non-limiting example, input multimedia content elements showing a dog approaching the car from 5 feet away that were captured by a camera deployed on a hood of the car may only match a reference multimedia content element showing a dog approaching the car from 5 feet away that was captured by a camera deployed on the hood or other area on the front side of the car.

In an embodiment, when a potential collision is detected, the alert generator 130 is configured to generate an alert. The alert may indicate the potential cause of collision shown in the input multimedia content elements (i.e., a potential cause of collision associated with the matching reference multimedia content element), the at least one collision parameter associated with the matching reference multimedia content element, or both. The alert may further include one or more collision avoidance instructions that, when executed by a driving control system, configure the driving control system to move the vehicle so as to avoid the collision. The collision avoidance instructions may be instructions for configuring one or more portions of the driving control system such as, but not limited to, a braking system, a steering system, and the like.

In an embodiment, the alert generator 130 is configured to send the generated alert, the collision avoidance instructions, or both, to the driving control system 120. In another embodiment, the alert generator 130 may include the driving control system 120, and may be further configured to control the vehicle based on the collision avoidance instructions.

It should be noted that only one driving control system 120 and one application 125 are described herein above with reference to FIG. 1 merely for the sake of simplicity and without limitation on the disclosed embodiments. Multiple driving control systems may provide multimedia content elements via multiple applications 125, and appropriate driving decisions may be provided to each driving control system, without departing from the scope of the disclosure.

It should be noted that any of the driving control system 120, the sensors 160, the alert generator 130, and the database 150 may be integrated without departing from the scope of the disclosure.

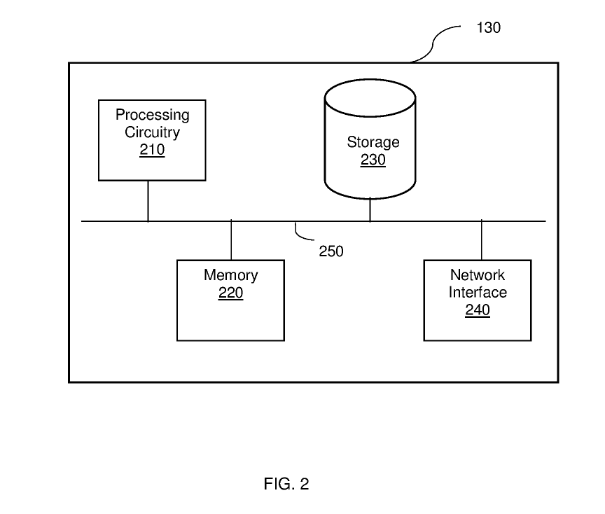

FIG. 2 is an example schematic diagram 200 of the alert generator 130 according to an embodiment. The alert generator 130 includes a processing circuitry 210 coupled to a memory 220, a storage 230, and a network interface 240. In an embodiment, the components of the alert generator 130 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information. In an embodiment, the processing circuitry 210 may be realized as an array of at least partially statistically independent computational cores. The properties of each computational core are set independently of those of each other core, as described further herein above.

The memory 220 may be volatile (e.g., RAM, etc.), non-volatile (e.g., ROM, flash memory, etc.), or a combination thereof. In one configuration, computer readable instructions to implement one or more embodiments disclosed herein may be stored in the storage 230.

In another embodiment, the memory 220 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 210, cause the processing circuitry 210 to perform the various processes described herein. Specifically, the instructions, when executed, cause the processing circuitry 210 to at least generate driving alerts based on multimedia content as described herein.

The storage 230 may be magnetic storage, optical storage, and the like, and may be realized, for example, as flash memory or other memory technology, CD-ROM, Digital Versatile Disks (DVDs), or any other medium which can be used to store the desired information.

The network interface 240 allows the alert generator 130 to communicate with the signature generator system 140 for the purpose of, for example, sending multimedia content elements, receiving signatures, and the like. Further, the network interface 240 allows the alert generator 130 to obtain multimedia content elements from as well as to send alerts and collision avoidance instructions to, e.g., the driving control system 120.

It should be understood that the embodiments described herein are not limited to the specific architecture illustrated in FIG. 2, and other architectures may be equally used without departing from the scope of the disclosed embodiments. In particular, the alert generator 130 may further include a signature generator system configured to generate signatures as described herein without departing from the scope of the disclosed embodiments.

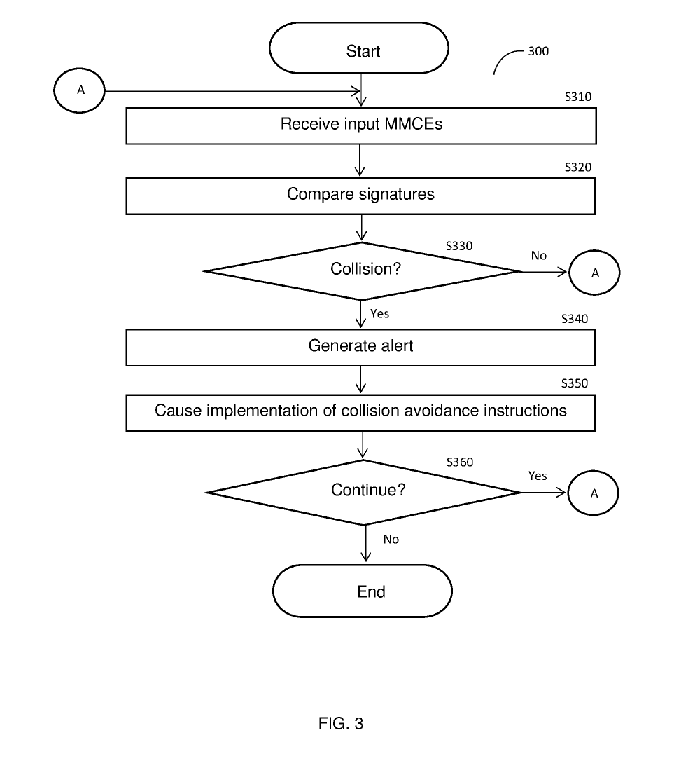

FIG. 3 depicts an example flowchart 300 illustrating a method for generating driving alerts based on multimedia content according to an embodiment. In an embodiment, the method may be performed by the alert generator 130 based on multimedia content elements captured by sensors (e.g., a camera) deployed in proximity to a vehicle such that the sensor signals indicate at least some features of the environment around the vehicle. The multimedia content elements may be captured during a trip, where the trip includes locomotion of the vehicle from a beginning location to a destination location.

At S310, input multimedia content elements (MMCEs) are received during the trip. The input multimedia content elements are captured by the sensors deployed in proximity to the vehicle and may be, e.g., received from the sensors, from a driving control system communicatively connected to the sensors, and the like. The trip multimedia content elements are received in real-time, thereby allowing for providing alerts to automated or assisted driving systems in real-time.

At least some of the trip multimedia content elements demonstrate potential causes of collision. Each potential cause of collision is an obstacle or other object that may collide with the vehicle. Potential causes of collision may include moving objects (e.g., pedestrians, other vehicles, animals, etc.) or stationary objects (e.g., signs, bodies of water, parked vehicles, statues, buildings, walls, etc.).

At S320, signatures of the input multimedia content elements are compared to signatures of a plurality of reference multimedia content elements. The reference multimedia content elements may include signatures previously generated to the reference multimedia content elements, signatures of concepts matching the reference multimedia content elements, and the like.

Each reference multimedia content element is a previously captured multimedia content element demonstrating a potential cause of collision. For example, the matching referennce multimedia content elements may be identified from among a plurality of predetermined event multimedia content elements captured by sensors of other vehicles. Each reference multimedia content element may be stored in, e.g., a database, and is associated with a predetermined potential cause of collision, at least one predetermined collision parameter (e.g., a distance of the potential cause of collision from the vehicle, an angle of the potential cause of collision with respect to the vehicle, etc.), at least one predetermined collision avoidance instruction, or a combination thereof. The collision parameters may be utilized by, e.g., a driving control system, to determine at least one action for avoiding the collision such as, but not limited to, changing direction, braking, accelerating, degrees thereof (e.g., an angle at which to change direction, a rate of deceleration or acceleration, etc.), combinations thereof, and the like.

In an embodiment, S320 may include generating or causing generation of at least one signature for each input multimedia content element and comparing the input multimedia content element signatures to signatures of the plurality of reference multimedia content elements. The reference multimedia content element signatures may be previously generated, or S320 may include generating the reference multimedia content element signatures.

In an embodiment, S320 includes generating the signatures via a plurality of at least partially statistically independent computational cores, where the properties of each core are set independently of the properties of the other cores. In another embodiment, S320 includes sending the multimedia content element to a signature generator system, to a deep content classification system, or both, and receiving the plurality of signatures. The signature generator system includes a plurality of at least statistically independent computational cores as described further herein. The deep content classification system is configured to create concepts for a wide variety of multimedia content elements, automatically and in an unsupervised fashion.

In an embodiment, S320 includes querying a DCC system using the generated signatures to identify at least one concept matching the multimedia content elements. The metadata of the matching concept is used for correlation between a first signature and at least a second signature.

At S330, based on the comparison, it is determined if a potential collision is detected and, if so, execution continues with S340; otherwise, execution continues with S310. In an embodiment, it is determined if a potential collision is detected when a reference multimedia content element matches one or more of the input multimedia content elements. In an embodiment, each matching reference multimedia content element has a signature matching signatures of one or more of the input multimedia content elements above a predetermined threshold.

In an optional embodiment, the matching reference multimedia content elements only include reference multimedia content elements associated with the same or a similar (e.g., on the same side of the vehicle) portion of the vehicle as the corresponding input multimedia content elements. To this end, each reference multimedia content element may be associated with a portion of the vehicle (e.g., front or rear side, left side or right side, a combination thereof, etc.) from which the reference multimedia content element was captured. As noted above, utilizing reference multimedia content elements having matching locations of capture relative to a vehicle in addition to having matching signatures allows for more accurate collision avoidance instructions, particularly since the optimal instructions for avoiding a collision may be different for, e.g., a front side of the vehicle as opposed to a rear side of the vehicle. As a non-limiting example, instructions for avoiding a potential collision identified based on video from a camera disposed on a front side of the vehicle may include braking or steering to avoid, while instructions for avoiding a potential collision identified based on video from a camera disposed on a rear side of the vehicle may include accelerating.

At S340, when a potential collision is detected, at least one alert is generated based on the matching reference multimedia content element. In an embodiment, the alert may indicate the potential cause of collision associated with the matching reference multimedia content element, the at least one collision parameter associated with the matching reference multimedia content element, or both. In an embodiment, S340 includes sending the generated alert to, e.g., a driving control system configured to control the vehicle in response to driving alerts.

At optional S350, the collision avoidance instructions associated with the matching reference multimedia content element are caused to be implemented. In an embodiment, S350 may include sending the determined decisions to a driving control system of the vehicle. In another embodiment, S350 may include controlling the vehicle based on the determined driving decisions (e.g., if the driving control system is configured to generate the alerts and obtain the collision avoidance instructions).

At S360, it is determined if additional input multimedia content elements have been received and, if so, execution continues with S310; otherwise, execution terminates. In an example implementation, execution may continue until the trip is completed by, for example, arriving at the destination location, the vehicle stopping at or near the destination location, and the like.

As a non-limiting example, input video is received from a dashboard camera mounted on a car and facing forward such that the dashboard camera captures video of the environment in front of the car. The captured input video is obtained in real-time and analyzed to generate signatures therefore. The generated signatures are compared to signatures of reference videos showing known causes of collision. Based on the comparison, a matching reference video showing a pedestrian entering a crosswalk is identified. The reference video is associated with a potential cause of pedestrian crossing and a collision parameter of 10 feet away from the vehicle. An alert indicating the pedestrian crossing 10 feet away from the vehicle is generated and sent to a driving control system of the vehicle. The driving control system causes the vehicle to brake in response to receiving the alert, thereby avoiding collision with the pedestrian.

FIGS. 4 and 5 illustrate the generation of signatures for the multimedia content elements by the SGS 140 according to an embodiment. An exemplary high-level description of the process for large scale matching is depicted in FIG. 4. In this example, the matching is for a video content.

Video content segments 2 from a Master database (DB) 6 and a Target DB 1 are processed in parallel by a large number of independent computational Cores 3 that constitute an architecture for generating the Signatures (hereinafter the “Architecture”). Further details on the computational Cores generation are provided below. The independent Cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 4. Finally, Target Robust Signatures and/or Signatures are effectively matched, by a matching algorithm 9, to Master Robust Signatures and/or Signatures database to find all matches between the two databases.

To demonstrate an example of the signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in-between the frames. In an embodiment the server 130 is configured with a plurality of computational cores to perform matching between signatures.

The Signatures' generation process is now described with reference to FIG. 5. The first step in the process of signatures generation from a given speech-segment is to breakdown the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the server 130 and SGS 140. Thereafter, all the K patches are injected in parallel into all computational Cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the Computational Cores 3 a frame ‘i’ is injected into all the Cores 3. Then, Cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Ci={nᵢ} (1≦i≦L) may consist of a single leaky integrate-to-threshold unit (LTU) node or more nodes. The node ni equations are:

$${V}_{i} = {\sum }_{j} {w}_{ij} {k}_{j}$$

$${n}_{i} = θ ( Vi - {Th}_{x} )$$

where, θ is a Heaviside step function; wᵢⱼ is a coupling node unit (CNU) between node i and image component j (for example, grayscale value of a certain pixel j); kj is an image component ‘j’ (for example, grayscale value of a certain pixel j); Thx is a constant Threshold value, where ‘x’ is ‘S’ for Signature and ‘RS’ for Robust Signature; and Vi is a Coupling Node Value.

The Threshold values Thx are set differently for Signature generation and for Robust Signature generation. For example, for a certain distribution of Vi values (for the set of nodes), the thresholds for Signature (Ths) and Robust Signature (Th_{RS}) are set apart, after optimization, according to at least one or more of the following criteria:

1: Vᵢ>Th_{RS}

1−p(V>Th_{S})−1−(1−ε)¹<<1

i.e., given that l nodes (cores) constitute a Robust Signature of a certain image I, the probability that not all of these I nodes will belong to the Signature of same, but noisy image, Ĩ is sufficiently low (according to a system's specified accuracy).

2: p(Vᵢ>Th_{RS})≈l/L

i.e., approximately l out of the total L nodes can be found to generate a Robust Signature according to the above definition.

3: Both Robust Signature and Signature are generated for certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. The detailed description of the Signature generation can be found in U.S. Pat. Nos. 8,326,775 and 8,312,031, assigned to the common assignee, which are hereby incorporated by reference.

A Computational Core generation is a process of definition, selection, and tuning of the parameters of the cores for a certain realization in a specific system and application. The process is based on several design considerations, such as:

(a) The Cores should be designed so as to obtain maximal independence, i.e., the projection from a signal space should generate a maximal pair-wise distance between any two cores' projections into a high-dimensional space.

(b) The Cores should be optimally designed for the type of signals, i.e., the Cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.

(c) The Cores should be optimally designed with regard to invariance to a set of signal distortions, of interest in relevant applications.

A detailed description of the Computational Core generation and the process for configuring such cores is discussed in more detail in U.S. Pat. No. 8,655,801 referenced above.

It should be noted that various embodiments described herein are discussed with respect to autonomous driving decisions and systems merely for simplicity and without limitation on the disclosed embodiments. The embodiments disclosed herein are equally applicable to other assisted driving systems such as, for example, accident detection systems, lane change warning systems, and the like. In such example implementations, the automated driving decisions may be generated, e.g., only for specific driving events.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the disclosed embodiments and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

What is claimed is:

1. A method for generating driving alerts based on multimedia content elements, comprising:
obtaining, in real-time during a trip of a vehicle, a first set of multimedia content elements captured by at least one sensor deployed in proximity to the vehicle; and
generating, in real-time, a driving alert, when it is determined that at least one signature generated for the first set of multimedia content elements matches at least one signature generated for a matching multimedia content element of a second set of multimedia content elements, wherein each of the second set of multimedia content elements is associated with a predetermined potential cause of collision.

2. The method of claim 1, further comprising:
sending, to a driving control system configured to control the vehicle, the generated driving alert.

3. The method of claim 1, wherein each multimedia content element is at least one of: an image, and a video.

4. The method of claim 1, wherein the alert indicates the potential cause of collision associated with the matching multimedia content element of the second set of multimedia content elements.

5. The method of claim 4, wherein each of the second set of multimedia content elements is further associated with at least one predetermined collision parameter, wherein the alert further indicates the at least one collision parameter associated with the matching multimedia content element of the second set of multimedia content elements.

6. The method of claim 4, wherein each of the second set of multimedia content elements is further associated with at least one predetermined collision avoidance instruction, further comprising:
causing a driving control system of the vehicle to execute the at least one collision avoidance instruction associated with the matching multimedia content element of the second set of multimedia content elements, wherein the at least one collision avoidance instruction, when executed by the driving control system, configures the driving control system to perform at least one action for avoiding the indicated potential cause of collision.

7. The method of claim 1, further comprising:
generating the at least one signature for the first set of input multimedia content elements, wherein each signature represents a concept, wherein each concept is a collection of signatures and metadata representing the concept.

8. The method of claim 7, further comprising:
comparing the at least one signature generated for the first set of multimedia content elements to a plurality of signatures generated for the second set of multimedia content elements, wherein each matching multimedia content element is one of the second set of multimedia content elements having a signature matching at least one of the at least one signature generated for the first set of multimedia content elements above a predetermined threshold.

9. The method of claim 7, wherein each signature is generated by a signature generator system, wherein the signature generator system includes a plurality of at least partially statistically independent computational cores, wherein the properties of each core are set independently of the properties of each other core.

10. A non-transitory computer readable medium having stored thereon instructions for causing a processing circuitry to execute a process, the process comprising:
obtaining, in real-time during a trip of a vehicle, a first set of multimedia content elements captured by at least one sensor deployed in proximity to the vehicle; and
generating, in real-time, a driving alert, when it is determined that at least one signature generated for the first set of multimedia content elements matches at least one signature generated for a matching multimedia content element of a second set of multimedia content elements, wherein each of the second set of multimedia content elements is associated with a predetermined potential cause of collision.

11. A system for determining driving decisions based on multimedia content elements, comprising:
a processing circuitry; and
a memory connected to the processing circuitry, the memory containing instructions that, when executed by the processing circuitry, configure the system to:
obtain, in real-time during a trip of a vehicle, a first set of multimedia content elements captured by at least one sensor deployed in proximity to the vehicle; and
generate, in real-time, a driving alert, when it is determined that at least one signature generated for the first set of multimedia content elements matches at least one signature generated for a matching multimedia content element of a second set of multimedia content elements, wherein each of the second set of multimedia content elements is associated with a predetermined potential cause of collision.

12. The system of claim 11, wherein the system is further configured to:
send, to a driving control system configured to control the vehicle, the generated driving alert.

13. The system of claim 11, wherein each multimedia content element is at least one of: an image, and a video.

14. The system of claim 11, wherein the alert indicates the potential cause of collision associated with the matching multimedia content element of the second set of multimedia content elements.

15. The system of claim 14, wherein each of the second set of multimedia content elements is further associated with at least one predetermined collision parameter, wherein the alert further indicates the at least one collision parameter associated with the matching multimedia content element of the second set of multimedia content elements.

16. The system of claim 14, wherein each of the second set of multimedia content elements is further associated with at least one predetermined collision avoidance instruction, wherein the system is further configured to:
cause a driving control system of the vehicle to execute the at least one collision avoidance instruction associated with the matching multimedia content element of the second set of multimedia content elements, wherein the at least one collision avoidance instruction, when executed by the driving control system, configures the driving control system to perform at least one action for avoiding the indicated potential cause of collision.

17. The system of claim 11, wherein the system is further configured to:
generate the at least one signature for the first set of input multimedia content elements, wherein each signature represents a concept, wherein each concept is a collection of signatures and metadata representing the concept.

18. The system of claim 17, wherein the system is further configured to:
compare the at least one signature generated for the first set of multimedia content elements to a plurality of signatures generated for the second set of multimedia content elements, wherein each matching multimedia content element is one of the second set of multimedia content elements having a signature matching at least one of the at least one signature generated for the first set of multimedia content elements above a predetermined threshold.

19. The system of claim 17, further comprising:
a signature generator system, wherein each signature is generated by the signature generator system, wherein the signature generator system includes a plurality of at least partially statistically independent computational cores, wherein the properties of each core are set independently of the properties of each other core.
